(19) United States
(12) Patent Application Publication
(10) Pub. No.: US 2023/0201073 A1
(43) Pub. Date: Jun. 29, 2023

(54) MULTI-FUNCTION MASSAGE DEVICE

(71) Applicant: XIAMEN COMFIER TECHNOLOGY CO., LTD., Xiamen (CN)

(72) Inventors: Jianqing Li, Xiamen (CN); Zhilong Chen, Xiamen (CN)

(21) Appl. No.: 17/728,901

(22) Filed: Apr. 25, 2022

(30) Foreign Application Priority Data
Dec. 28, 2021 (CN) 202123346257.7

(51) Int. Cl. A61H 23/02

(52) U.S. Cl. CPC A61H 23/0254; A61H 2201/0134; A61H 2201/0207; A61H 2201/0228

(57) ABSTRACT

A multi-function massage device includes a controller and a plurality of connected pillow units that are foldable. The pillow units are a one-piece structure. At least one massage unit is fixedly installed in at least one of the pillow units. The controller controls the massage unit to perform a massage action. The overall structure is simple and lightweight. When all the pillow units are folded together, they can be used as a pillow or cushion. When all the pillow units are unfolded, the user can control the massage unit to perform a massage action through the controller for massaging the user's body.

### BACKGROUND OF THE INVENTION

### 1. Field of the Invention

The present invention relates to a massage device, and more particularly to a multi-function massage device.

### 2. Description of the Prior Art

With the improvement of living standards, people pay more and more attention to health. Therefore, massage equipment used for performing a massage on a user is becoming more and more popular in the market, especially massage devices with more functions.

The massage devices on the market are usually relatively large in size, difficult to carry and move, inconvenient to use, and unable to meet people' needs. Therefore, there are some foldable massage devices on the market. Although these foldable massage devices meet the needs of moving around and storing, these foldable massage devices are folded through a rotating mechanical structure. This makes the structure of these foldable massage devices complicated and bulky.

### SUMMARY OF THE INVENTION

The primary object of the present invention is to provide a multi-function massage device that has a simple structure and is light in weight.

In order to achieve the above object, the present invention adopts the following technical solutions.

A multi-function massage device comprises a controller and a plurality of connected pillow units that are foldable. The pillow units are a one-piece structure. At least one massage unit is fixedly installed in at least one of the pillow units. The controller controls the massage unit to perform a massage action.

Preferably, a heating element is fixedly installed in at least one of the pillow units.

Preferably, the heating element is a heating wire.

Preferably, the massage unit includes a motor and a massage head. The motor drives the massage head to turn. The controller controls the motor to work.

Preferably, a plurality of massage units is fixedly installed in at least two of the pillow units respectively. The controller is electrically connected to a main connection wire. The main connection wire is connected to a secondary connection wire having a power connector and a main plug connector. The main plug connector and an auxiliary plug connector of an extension wire are connected to each other by plugging.

Preferably, the heating element is provided in at least two of the pillow units. The motors of the massage units in the same pillow unit are connected in series through wires. A connecting wire between the motors at respective ends of every adjacent two of the pillow units, a connecting wire between the heating elements of every adjacent two of the pillow units, a connecting wire between one of the heating elements and the extension wire and a connecting wire between one of the motors and the extension wire are connected to each other through male terminals and female terminals to be mated with each other.

Preferably, at least one of the pillow units is provided with a strap.

Preferably, the strap includes a first strap and a second strap that are detachably connected.

Preferably, the first strap and the second strap are detachably connected through a hook-and-loop fastener.

Preferably, the first strap and the second strap each have a length parallel to a foldable connecting edge between the pillow units.

Preferably, a seal structure is provided between the uppermost one of the pillow units and the lowermost one of the pillow units when the pillow units are in a folded state, so that the pillow units can be kept in the folded state.

Preferably, the seal structure is a zipper structure with a zipper puller.

Preferably, the number of the pillow units is three.

Preferably, the massage unit in the pillow unit includes at least three massage units.

In the present invention, the pillow units are a one-piece structure. The connected pillow units are foldable. Every adjacent two of the pillow units are connected through a foldable connecting edge between them, so that a bendable soft connection is formed between every adjacent two of the pillow units. There is no need to provide an additional rotating mechanical structure for folding. The overall structure is simple and lightweight. When all the pillow units are folded together along their foldable connecting edges in turn, they can be used as a pillow or cushion, etc. When all the pillow units are unfolded, the user can control the massage unit to perform a massage action through the controller for massaging the user's body to relieve fatigue.

### BRIEF DESCRIPTION OF THE DRAWINGS

FIG. 1 is a perspective view of the present invention after being folded;

FIG. 2 is a perspective view of the present invention after being unfolded;

FIG. 3 is a front view of the present invention after being unfolded;

FIG. 4 is a schematic view of the present invention after being unfolded; and

FIG. 5 is a schematic view of the internal circuit wiring of the present invention.

### DETAILED DESCRIPTION OF THE PREFERRED EMBODIMENTS

Embodiments of the present invention will now be described, by way of example only, with reference to the accompanying drawings.

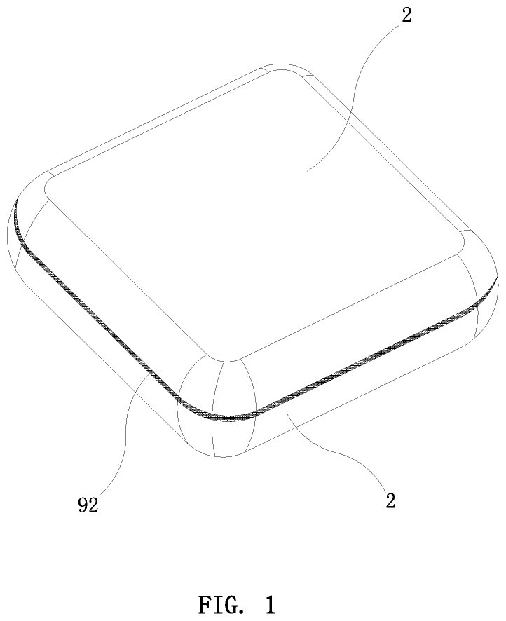

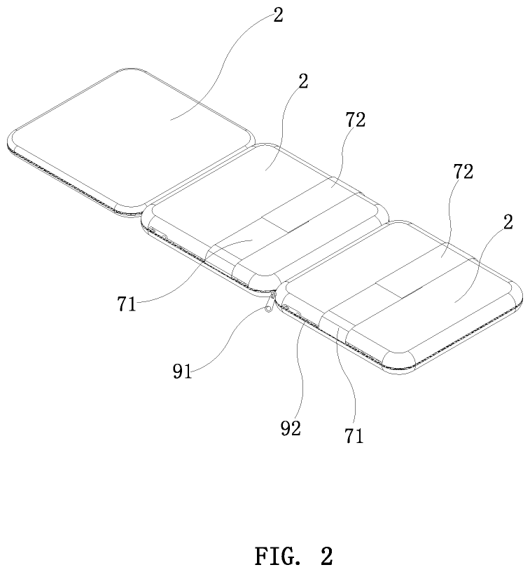

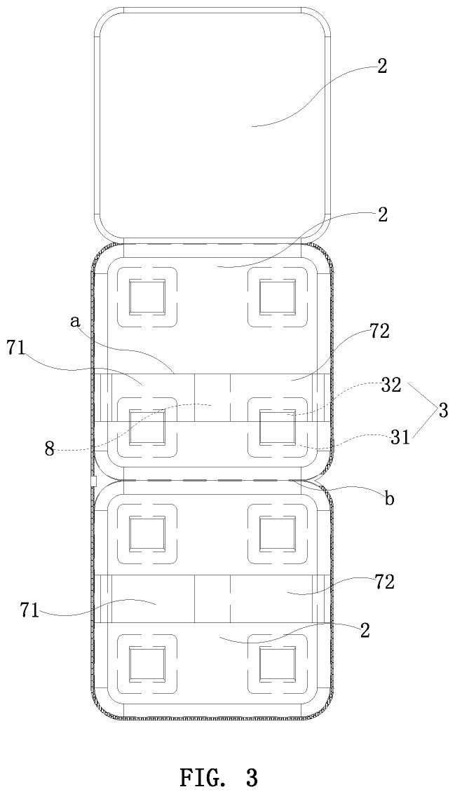

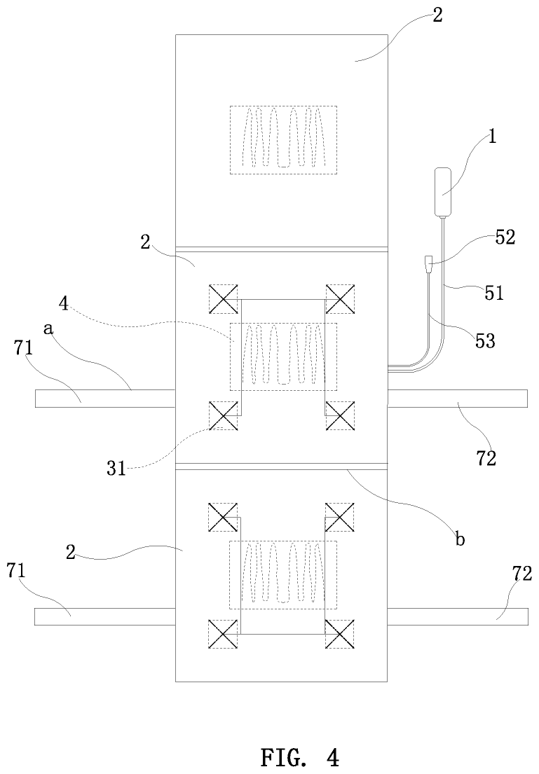

Please refer to FIGS. 1 to 5. The present invention discloses a multi-function massage device, comprising a controller 1 and a plurality of connected pillow units 2 that are foldable. The pillow units 2 are a one-piece structure. At least one massage unit 3 is fixedly installed in at least one of the pillow units 2. The controller 1 controls the massage unit 3 to perform a massage action.

In the present invention, the pillow units 2 are a one-piece structure. The connected pillow units 2 are foldable. Every adjacent two of the pillow units 2 are connected through a foldable connecting edge b between them, so that a bendable soft connection is formed between every adjacent two of the pillow units 2. There is no need to provide an additional rotating mechanical structure for folding. The overall structure is simple and lightweight. When all the pillow units 2 are folded together along their foldable connecting edges b in turn, they can be used as a pillow or cushion, etc. When all the pillow units 2 are unfolded, the user can control the massage unit 3 to perform a massage action through the controller 1 for massaging the user's body to relieve fatigue.

Furthermore, in order to enhance the massage effect of the present invention, a heating element is fixedly installed in at least one of the pillow units 2. The controller 1 controls the heating element to perform a heating action, so as to achieve a heating massage. In order to simplify the structure of the present invention, the heating element may be a heating wire 4, but not limited thereto. The heating element may use other kinds of heating elements.

In order to simplify the structure of the present invention, the massage unit 3 may include a motor 31 and a massage head 32. The motor 31 drives the massage head 32 to turn. The controller 1 controls the motor 31 to work. A sponge is attached to the outer side of the motor 31 to reduce the vibration sound.

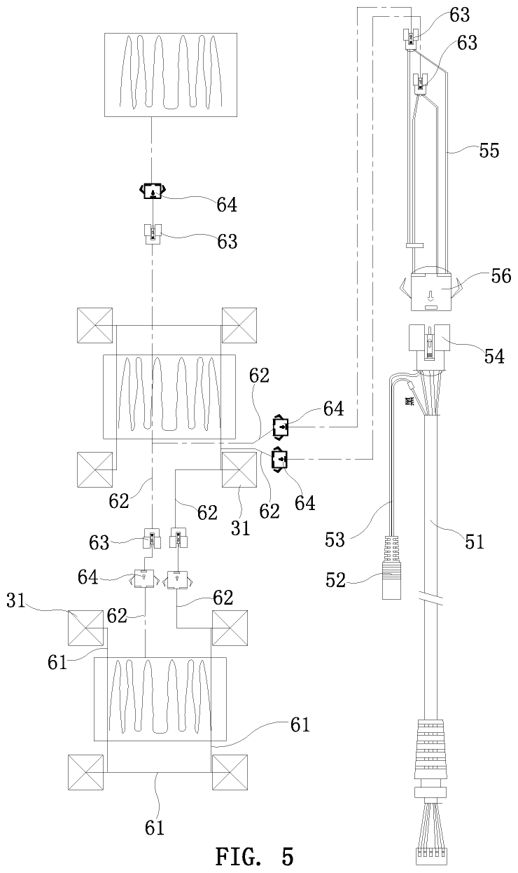

In order to facilitate the quick connection of the circuit of the present invention, as shown in FIG. 5, a plurality of massage units 3 is fixedly installed in at least two of the pillow units 2, respectively. The controller 1 is electrically connected to a main connection wire 51. The main connection wire 51 is connected to a secondary connection wire 53 having a power connector 52 and a main plug connector 54. The main plug connector 54 and an auxiliary plug connector 56 of an extension wire 55 are connected to each other by plugging.

For the circuit of the present invention to be quickly connected, referring to FIG. 5, at least two of the pillow units 2 are provided with heating elements, respectively. The motors 31 of the massage units 3 in the same pillow unit 2 are connected in series through wires 61.

A connecting wire 62 between the motors 31 at the respective ends of every adjacent two of the pillow units 2, a connecting wire 62 between the heating elements of every adjacent two of the pillow units 2, a connecting wire between one of the heating elements and the extension wire 55, and a connecting wire 62 between one of the motors 31 and the extension wire 55 are connected to each other through male terminals 63 and female terminals 64 to be mated with each other.

Further, in order to facilitate the multi-function massage device provided by the present invention to be secured on a massage chair for performing a heating and vibration massage on the human body, at least one of the pillow units 2 is provided with a strap 7, so that the multi-function massage device can be tied to the massage chair through the strap 7.

In order to facilitate the binding of the strap 7 on the massage chair, the strap 7 includes a first strap 71 and a second strap 72. The first strap 71 and the second strap 72 are detachably connected.

In addition, in order to simplify the structure and facilitate the unfolded massage device to be secured on the massage chair, the length a of the first strap 71 and the length a of the second strap 72 are both parallel to the foldable connecting edge b between the pillow units 2.

Further, in order to simplify the structure of the present invention, the first strap 71 and the second strap 72 are detachably connected through a hook-and-loop fastener 8. Through the hook-and-loop fastener 8, the first strap 71 and the second strap 72 can be connected together, so that the massage unit can be secured on the massage chair quickly.

A seal structure is provided between the uppermost pillow unit 2 and the lowermost pillow unit 2 when the pillow units 2 are in a folded state, so that the pillow units 2 can be kept in the folded state to prevent the pillow units 2 from loosening after being folded. In this embodiment, the seal structure is a zipper structure 92 with a zipper puller 91. The upper end of the zipper structure 92 is sewn to the uppermost pillow unit 2, and the lower end of the zipper structure 92 is sewn to the lowermost pillow unit 2. When the user opens the zipper structure 92 by pulling the zipper puller 91, the pillow units 2 can be unfolded. The pillow units 2 can be laid flat on a sofa bed or placed on a massage chair. When the user closes the zipper structure 92 by pulling the zipper head 92, the pillow units 2 are kept in the folded state, which can be used as a pillow or cushion.

In this embodiment, the number of the pillow units 2 is three. The heating element is fixedly installed in each of the pillow units 2. When the present invention is tied to the massage chair, the pillow units 2 are used to massage the user's head, back and buttocks, respectively. The number of massage units 3 of the pillow units 2 is at least three, forming an area for massage. In the embodiment, the number of massage units 3 in two of the pillow units 2 is four, and the other pillow unit 2 doesn't have the massage unit. The pillow units 2 are symmetrically distributed and evenly spaced. The head of the user can be positioned on the pillow unit 2 having the heating element or on one of the pillow units 2 having four massage units 3. Two of the pillow units 2 are provided with straps 7.

Although particular embodiments of the present invention have been described in detail for purposes of illustration, various modifications and enhancements may be made without departing from the spirit and scope of the present invention. Accordingly, the present invention is not to be limited except as by the appended claims

What is claimed is:

1. A multi-function massage device, comprising a controller and a plurality of connected pillow units that are foldable, the pillow units being a one-piece structure, at least one massage unit being fixedly installed in at least one of the pillow units, the controller controlling the massage unit to perform a massage action.

2. The multi-function massage device as claimed in claim 1, wherein a heating element is fixedly installed in at least one of the pillow units.

3. The multi-function massage device as claimed in claim 2, wherein the heating element is a heating wire.

4. The multi-function massage device as claimed in claim 1, wherein the massage unit includes a motor and a massage head, the motor drives the massage head to turn, and the controller controls the motor to work.

5. The multi-function massage device as claimed in claim 2, wherein a plurality of massage units are fixedly installed in at least two of the pillow units respectively, the controller is electrically connected to a main connection wire, the main connection wire is connected to a secondary connection wire having a power connector and a main plug connector, and the main plug connector and an auxiliary plug connector of an extension wire are connected to each other by plugging.

6. The multi-function massage device as claimed in claim 5, wherein the heating element is provided in at least two of the pillow units, the motors of the massage units in the same pillow unit are connected in series through wires, a connecting wire between the motors at respective ends of every adjacent two of the pillow units, a connecting wire between the heating elements of every adjacent two of the pillow units, a connecting wire between one of the heating elements and the extension wire and a connecting wire between one of the motors and the extension wire are connected to each other through male terminals and female terminals to be mated with each other.

7. The multi-function massage device as claimed in claim 1, wherein at least one of the pillow units is provided with a strap.

8. The multi-function massage device as claimed in claim 7, wherein the strap includes a first strap and a second strap that are detachably connected.

9. The multi-function massage device as claimed in claim 8, wherein the first strap and the second strap are detachably connected through a hook-and-loop fastener.

10. The multi-function massage device as claimed in claim 8, wherein the first strap and the second strap each have a length parallel to a foldable connecting edge between the pillow units.

11. The multi-function massage device as claimed in claim 1, wherein a seal structure is provided between the uppermost one of the pillow units and the lowermost one of the pillow units when the pillow units are in a folded state, so that the pillow units can be kept in the folded state.

12. The multi-function massage device as claimed in claim 11, wherein the seal structure is a zipper structure with a zipper puller.

13. The multi-function massage device as claimed in claim 1, wherein the number of the pillow units is three.

14. The multi-function massage device as claimed in claim 1, wherein the massage unit in the pillow unit includes at least three massage units.
